(19) United States
(12) Patent Application Publication
(10) Pub. No.: US 2018/0180878 A1
(43) Pub. Date: Jun. 28, 2018

(54) HEAD-UP DISPLAY DEVICE

(71) Applicant: DENSO CORPORATION, Kariya-city, Aichi-pref. (JP)

(72) Inventors: Junya YOKOE, Kariya-city (JP); Takahiro NAMBARA, Kariya-city (JP)

(21) Appl. No.: 15/736,143

(22) PCT Filed: Jun. 7, 2016
(86) PCT No.: PCT/JP2016/002741

§ 371 Date: Dec. 13, 2017

(30) Foreign Application Priority Data
Jun. 26, 2015 (JP) 2015-129174

(51) Int. Cl. G02B 27/01; B60K 35/00; G02B 5/30

(52) U.S. Cl. CPC G02B 27/0101; B60K 35/00; G02B 5/3083; G02B 2027/0118; B60K 2350/2052; B60K 2350/2069; B60K 2350/2056; G02B 5/3025

(57) ABSTRACT

A head-up display device is mounted in a vehicle and virtually displays an image to be viewable by an occupant by projecting the image on a light-transmissive projection member. The head-up display device includes a projector that projects the image as light polarized in a direction of a polarization axis, a polarizer that is disposed on an optical path of the light of the image and has a property of transmitting light polarized along a transmission axis, and a phase shifter that is disposed between the polarizer and the projection member on the optical path and has a property of changing a polarization direction of transmitted light by producing a phase difference. A fast axis direction of the phase shifter intersects with a direction corresponding to the polarization axis, a direction corresponding to the transmission axis, and a direction corresponding to S polarization of the projection member.

### CROSS REFERENCE TO RELATED APPLICATION

This application is based on Japanese Patent Application No. 2015-129174 filed on Jun. 26, 2015, the disclosure of which is incorporated herein by reference.

### TECHNICAL FIELD

The present disclosure relates to a head-up display device (hereinafter abbreviated as an HUD device) that is to be mounted in a vehicle and to virtually display an image to be viewable by an occupant.

### BACKGROUND ART

Conventionally, there has been known an HUD device that is mounted in a vehicle and virtually displays an image to be viewable by an occupant. An HUD device disclosed in Patent Literature 1 projects an image on a light-transmissive projection member. The HUD device includes a projector that projects an image as light polarized in a direction corresponding to a polarization axis, a polarizer that is disposed on an optical path formed by the light of the image and has a property of transmitting light polarized along a transmission axis, and a phase shifter disposed on the optical path. The phase shifter produces a phase difference of λ/4, and thereby converts linearly polarized light from the projector into circularly polarized light.

### PRIOR ART LITERATURE

### Patent Literature

Patent Literature 1: JP 2008-70504 A

### SUMMARY OF INVENTION

There are cases where external light such as sunlight enters the HUD device and reaches the projector, thereby increasing the temperature of the projector. The present inventors have intensively studied the properties of the external light, and have found that the external light that is transmitted through the projection member and enters the HUD device is easily partially polarized in a direction corresponding to the P polarization of the projection member. That is, the present inventors have found the possibility of, by disposing a proper phase shifter in consideration of the partially polarized light, efficiently shielding the external light by the polarizer while suppressing brightness reduction of virtual image display, and thereby suppressing temperature rise of the projector.

It is an object of the present disclosure to provide an HUD device that can suppress temperature rise of a projector while suppressing brightness reduction of virtual image display.

According to a first aspect of the present disclosure, a head-up display device is to be mounted in a vehicle and to virtually display an image to be viewable by an occupant by projecting the image on a light-transmissive projection member. The head-up display device includes a projector that projects the image as light polarized in a direction of a polarization axis, a polarizer that is disposed on an optical path of the light of the image and has a property of transmitting light polarized along a transmission axis, and a phase shifter that is disposed between the polarizer and the projection member on the optical path and has a property of changing a polarization direction of transmitted light by producing a phase difference. A fast axis direction of the phase shifter intersects with a direction corresponding to the polarization axis, a direction corresponding to the transmission axis, and a direction corresponding to S polarization of the projection member.

In the above configuration, the phase shifter is disposed between the polarizer and the projection member on the optical path formed by the light of the image projected by the projector. In the case where the external light transmitted through the projection member enters the HUD device with this disposition, e.g. in the state of being partially polarized in the direction corresponding to the P polarization of the projection member; since the fast axis direction of the phase shifter intersects with the direction corresponding to the S polarization of the projection member, it is possible to perform the setting of changing the direction of the partially polarized light of the external light in matching with the polarizer. Further, since the direction corresponding to the polarization axis and the direction corresponding to the transmission axis intersect with the fast axis direction, it is possible to perform the setting of efficiently shielding by the phase shifter the external light traveling toward the projector and efficiently transmitting the light of the image from the projector toward the projection member. Therefore, it is possible to provide the HUD device that suppresses temperature rise of the projector while suppressing brightness reduction of the virtual image display.

According to a second aspect of the present disclosure, a head-up display device is to be mounted in a vehicle and to virtually display an image to be viewable by an occupant by projecting the image on a light-transmissive projection member. The head-up display device includes a projector that projects the image as light polarized in a direction corresponding to a polarization axis, a polarizer that is disposed on an optical path of the light of the image and has a property of transmitting light polarized along a transmission axis, and a phase shifter that is disposed between the projector and the polarizer on the optical path and has a property of changing a polarization direction of transmitted light by producing a phase difference. A fast axis direction of the phase shifter intersects with a direction corresponding to the polarization axis, a direction corresponding to the transmission axis, and a direction corresponding to S polarization of the projection member.

In the above configuration, the phase shifter is disposed between the projector and the polarizer on the optical path formed by the light of the image projected by the projector. In the HUD device with this disposition, since the fast axis direction of the phase shifter intersects with the direction corresponding to the polarization axis, it is possible to perform the setting of changing the polarization direction of the light of the image projected by the projector in matching with the polarizer. Further, in the case where the external light transmitted through the projection member enters the polarizer, e.g. in the state of being partially polarized in the direction corresponding to the P polarization of the projection member; since the direction corresponding to the transmission axis and the direction corresponding to the S polarization of the projection member intersect with the fast axis direction, it is possible to perform the setting of efficiently shielding the external light traveling toward the projector and efficiently transmitting the light of the image from the projector toward the projection member. Therefore, it is possible to provide the HUD device that suppresses temperature rise of the projector while suppressing brightness reduction of the virtual image display.

### BRIEF DESCRIPTION OF DRAWINGS

The above and other objects, features and advantages of the present disclosure will become more apparent from the following detailed description made with reference to the accompanying drawings, in which:

FIG. 1 is a schematic view showing a mounting state of an HUD device according to a first embodiment to a vehicle;

FIG. 2 is a schematic view showing a schematic configuration of the HUD device according to the first embodiment;

FIG. 3 is a perspective view showing the configuration of a projector according to the first embodiment;

FIG. 4 is a view for explaining the light of an image and the polarization of external light in the first embodiment;

FIG. 5 is a view for explaining the angle of a fast axis direction in an equation 4 according to the first embodiment;

FIG. 6 is a view for explaining the range of the fast axis direction in an equation 3 according to the first embodiment;

FIG. 7 is a graph showing the simulation result of the brightness of virtual image display and sunlight transmittance;

FIG. 8 is a schematic view showing a schematic configuration of an HUD device according to a second embodiment; and

FIG. 9 is a view for explaining the light of an image and the polarization of external light in the second embodiment.

### DESCRIPTION OF EMBODIMENTS

Hereinafter, various embodiments of the present disclosure will be described with reference to the accompanying drawings. In the following embodiments, corresponding components are denoted by the same reference numerals, and redundant description may be omitted. In each embodiment, when only a part of a configuration is described, another embodiment previously described can be employed for other parts of the configuration. Further, it is possible to not only combine configurations as specified in the description of the embodiments but also partially combine configurations of embodiments even though not specified herein as long as the combination poses no problem.

### First Embodiment

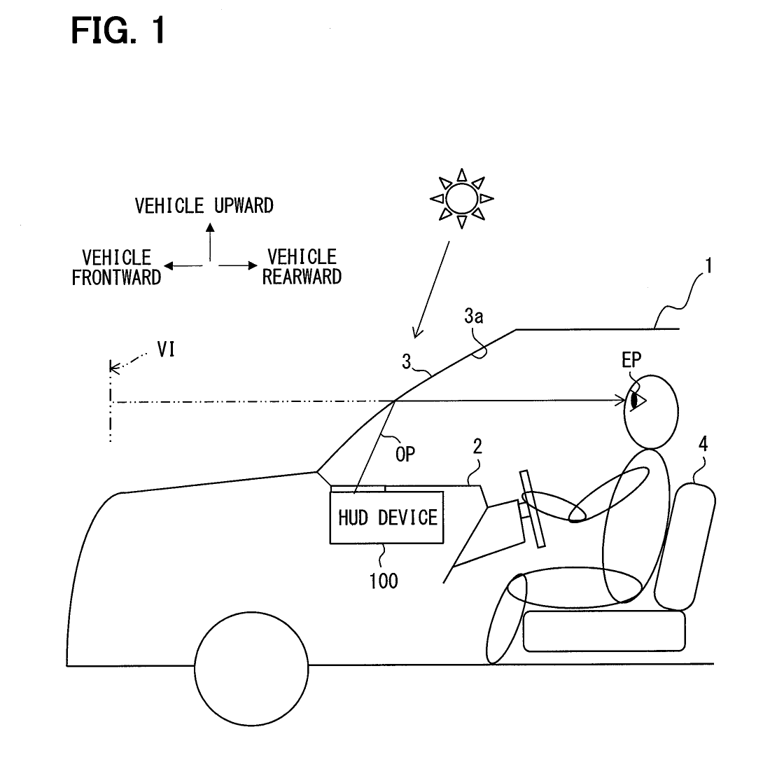

As shown in FIG. 1, an HUD device 100 according to a first embodiment of the present disclosure is mounted in a vehicle 1, and housed in an instrument panel 2. The HUD device 100 projects an image on a windshield 3 as a projection member of the vehicle 1. The light of the image is reflected by the windshield 3, so that the HUD device 100 virtually displays an image to be viewable by an occupant of the vehicle 1. That is, the light of the image reflected by the windshield 3 reaches an eye point EP of the occupant inside the vehicle 1, and the occupant perceives the light of the image as a virtual image VI. Accordingly, the occupant can visually recognize various kinds of information through the virtual image VI. The various kinds of information virtually displayed as the image include, for example, vehicle state values such as a vehicle speed and a fuel remaining amount, or navigation information such as road information and vision auxiliary information.

The windshield 3 of the vehicle 1 is located above the instrument panel 2 in a vehicle upward direction, and formed into a light-transmissive plate made of glass, synthetic resin, or the like. The windshield 3 is disposed inclined in a vehicle rearward direction as going toward the vehicle upper side. An interior surface of the windshield 3 includes a projection surface 3a to which the image is projected, and the projection surface 3a has a concave shape or a flat plane shape. Thus, the occupant who sits on a seat 4 of the vehicle 1 and faces in a vehicle frontward direction visually recognizes the foreground including roads and road signs through the windshield 3, and can also visually recognize the virtual display of the image.

In this context, the vehicle upward direction refers to a direction opposite to a direction in which gravity acts when the vehicle travels or stops on a flatland. The vehicle frontward direction refers to the direction of the front toward which the occupant sitting on the seat faces. The vehicle rearward direction refers to a direction opposite to the vehicle frontward direction.

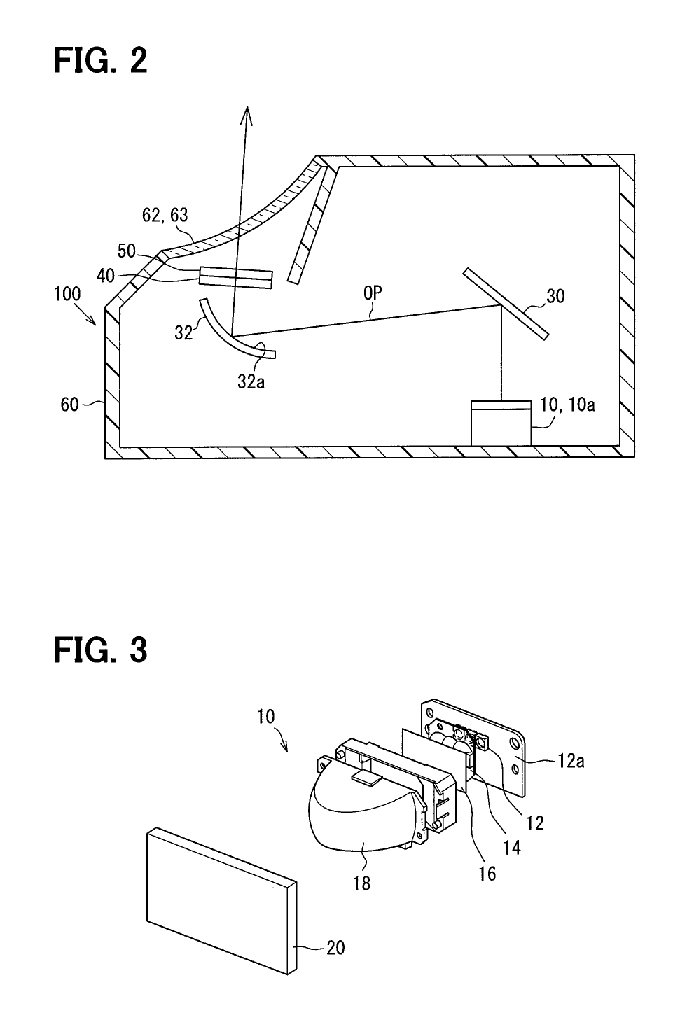

Hereinafter, the specific configuration of the HUD device 100 will be described with reference to FIGS. 2 to 6. As shown in FIG. 2, the HUD device 100 includes a projector 10, a plane mirror 30, a concave mirror 32, a polarizing plate 40 as a polarizer, and a retardation plate 50 as a phase shifter. The elements 10, 30, 32, 40, 50 are stably held and housed in a housing 60.

As shown in detail in FIG. 3, the projector 10 includes a light source 12, a condenser lens 14, a diffusion plate 16, a projection lens 18, and a liquid crystal panel 20, which are housed, for example, in a box-shaped projector case 10a.

The light source 12 is composed of, e.g., a plurality of light emitting diode elements, and disposed on a circuit board 12a for the light source. The light source 12 is electrically connected to a power supply through a wiring pattern on the circuit board 12a for the light source. The light source 12 emits light-source light with an emission amount according to a current amount by energization. The light source 12 thereby projects the light-source light toward the condenser lens 14. More specifically, in the light source 12, pseudo white light is achieved by covering a blue light emitting diode with a fluorescent substance.

The condenser lens 14 is a light-transmissive convex lens made of synthetic resin, glass, or the like, and is disposed between the light source 12 and the diffusion plate 16. The condenser lens 14 condenses the light-source light from the light source 12 and emits the light toward the diffusion plate 16.

The diffusion plate 16 is a plate formed of synthetic resin, glass, or the like, and is disposed between the condenser lens 14 and the projection lens 18. The diffusion plate 16 emits, toward the projection lens 18, the light source light whose brightness uniformity has been adjusted by diffusion.

The projection lens 18 is a light-transmissive convex lens made of synthetic resin, glass, or the like, and is disposed between the diffusion plate 16 and the liquid crystal panel 20. The projection lens 18 condenses the light-source light from the diffusion plate 16 and projects the light toward the liquid crystal panel 20.

The liquid crystal panel 20 is a liquid crystal panel using e.g. thin film transistors (TFTs), and is an active matrix type liquid crystal panel formed of a plurality of liquid crystal pixels arranged in two-dimensional directions. In the liquid crystal panel 20, a pair of polarizing plates, a liquid crystal layer sandwiched between the pair of polarizing plates, and the like are stacked. The polarizing plate has a property of transmitting light polarized in a predetermined direction and shielding light polarized in another predetermined direction, and the pair of polarizing plates are arranged so that the respective predetermined directions are substantially orthogonal to each other. By voltage application to each liquid crystal pixel, the liquid crystal layer can rotate the polarization direction of light entering the liquid crystal layer in accordance with the applied voltage.

Therefore, the liquid crystal panel 20 controls the transmittance of light-source light for each liquid crystal pixel, so the projector 10 can project an image. The image projected from the projector 10 is projected as light polarized in the direction of a polarization axis 21 as the predetermined direction of the polarizing plate on the emission side. Thus, an optical path OP is formed, by the light of the image, from the projector 10 to the windshield 3.

The plane mirror 30 is disposed on the optical path OP, and is a cold mirror constituted by forming a dielectric multilayer film on the surface of a light-transmissive substrate made of synthetic resin, glass, or the like. The plane mirror 30 has a property of reflecting visible light and transmitting infrared light and ultraviolet light. The plane mirror 30 reflects the visible light of the image from the projector 10 toward the concave mirror 32.

The concave mirror 32 is disposed on the optical path OP, and formed by depositing aluminum as a reflecting surface 32a on the surface of a substrate made of synthetic resin, glass, or the like. The reflecting surface 32a is formed into a smooth plane as a concave surface with the center of the concave mirror 32 concaved. The concave mirror 32 reflects the light of the image from the plane mirror 30 toward the polarizing plate 40.

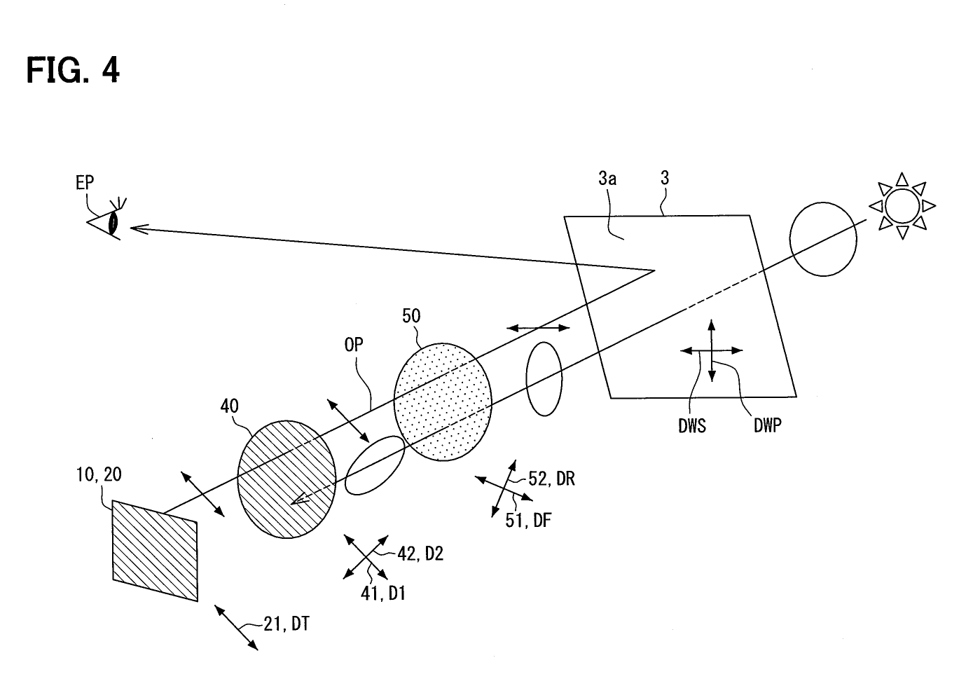

The polarizing plate 40 is disposed on the optical path OP as shown in FIGS. 2 and 4, and is a polarizer formed into a sheet by adding iodine to polyvinyl alcohol, for example. The polarizing plate 40 has a property of transmitting light polarized along a transmission axis 41 and shielding light polarized along a light-shielding axis 42 substantially orthogonal to the transmission axis 41. In this embodiment, the light-shielding axis 42 is an absorption axis which absorbs light. By the setting of the transmission axis 41 described later, the light of the image is transmitted through the polarizing plate 40, and then enters the retardation plate 50.

The retardation plate 50 is disposed between the polarizing plate 40 and the windshield 3 on the optical path OP as shown in FIGS. 2 and 4, and is a phase shifter formed like a flat plate made of a birefringent material, for example. The retardation plate 50 and the polarizing plate 40 are stuck together into an integrated plate. The retardation plate 50 has a property of changing the polarization direction of transmitted light by producing a phase difference. That is, light polarized in the direction of a fast axis 51 (hereinafter referred to as a fast axis direction DF) is advanced in phase relative to light polarized in the direction DR of a slow axis 52 substantially orthogonal to the fast axis direction DF, thereby producing a phase difference. The phase difference R of the retardation plate 50 is set in a range expressed by the following equation 1, using a wavelength λ of the light of the image from the projector 10.

(¼+m)·λ<R<(¾+m)·λ <Equation 1>

Further, it is preferable that the phase difference R is set so as to satisfy the following equation 2, and in this embodiment, the phase difference R is set in this way.

R=(½+m)·λ <Equation 2>

Particularly in this embodiment, a green wavelength of 560 nm with high visible sensitivity in the light of the image is adopted as the wavelength λ in the equations 1 and 2. In the equations 1 and 2, m is any integer of 0 or more.

By the setting of the fast axis direction DF described later, the light of the image transmitted through the retardation plate 50 changes the polarization direction as shown in FIG. 4, and enters the windshield 3 through a dustproof window 62 directed in the vehicle upward direction as shown in FIG. 2. The dustproof window 62 is provided with a light-transmissive plate 63 made of e.g. acrylic resin, which transmits the light of the image and prevents the invasion of foreign matter from the outside into the HUD device 100.

The setting of the fast axis direction of the retardation plate 50 will be described in detail with reference to FIGS. 4 to 6. As shown in FIG. 4, the light of the image from the projector 10 enters the retardation plate 50 according to the first embodiment. On the other hand, external light such as sunlight enters the retardation plate 50 through the windshield 3. The external light transmitted through the windshield 3 from e.g. the vehicle upper side becomes partially polarized light including a lot of P polarization components of the windshield 3 because the S polarization reflectance of the windshield 3 is higher than the P polarization reflectance. For example, in the case where the external light is sunlight, although an incident direction to the windshield 3 varies in accordance with situations such as the direction of the vehicle 1 and a time, the external light entering the HUD device 100 becomes such partially polarized light even if there is a slight direction error.

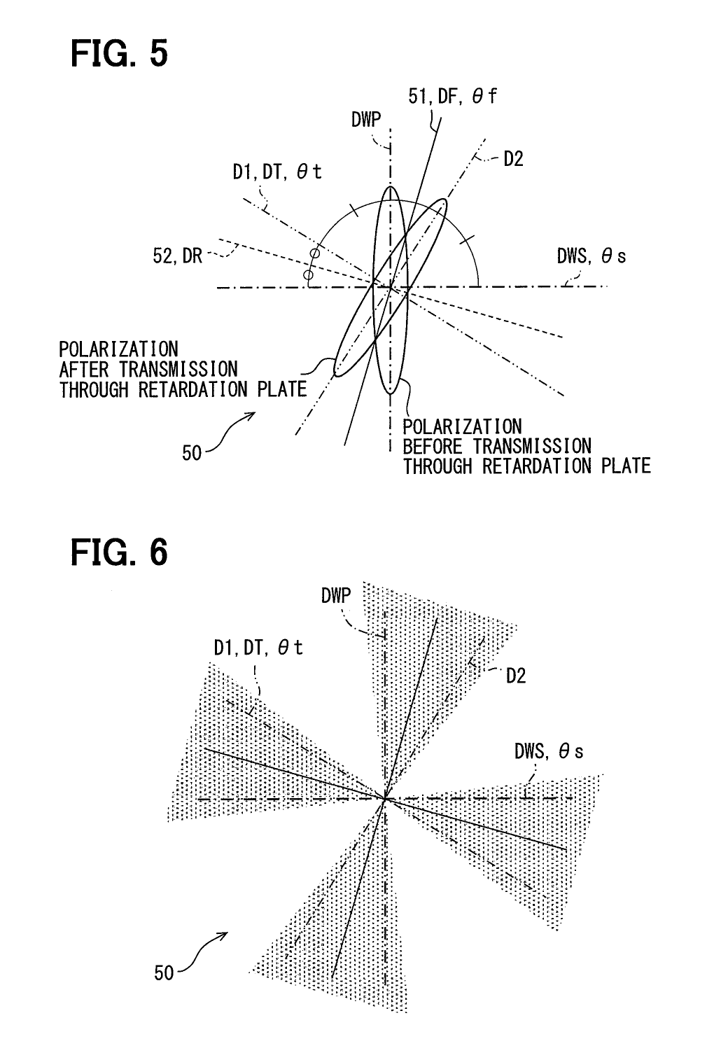

The fast axis direction DF is set so as to intersect with a direction DT corresponding to the polarization axis 21 of the projector 10, a direction D1 corresponding to the transmission axis 41 of the polarizing plate 40, and a direction DWS corresponding to the S polarization of the windshield 3. As a supplement, there is a correspondence relation in which the directions DT, D1, and DWS intersect with the fast axis direction DF on the plate surface of the retardation plate 50 shown in FIGS. 5 and 6.

In the first embodiment, the transmission axis 41 of the polarizing plate 40 is disposed in the direction DT corresponding to the polarization axis 21, and, for example, matches the direction DT. In this first embodiment, the angle θf of the fast axis direction DF is set in a range expressed by the following equation 3, using the angle θt of the direction DT corresponding to the polarization axis 21 and the angle θs of the direction DWS corresponding to the S polarization of the windshield 3.

$$\frac{( {θ}_{s} + {θ}_{t} )}{2} + 90 \cdot n - 22.5 < {θ}_{f} < \frac{( {θ}_{s} + {θ}_{t} )}{2} + 90 \cdot n + 22.5 \qquad 〈 Equation 3 〉$$

Further, it is preferable that the angle θf is set so as to satisfy the following equation 4, and in this embodiment, the angle θf is set in this way.

$${θ}_{f} = \frac{( {θ}_{s} + {θ}_{t} )}{2} + 90 \cdot n \qquad 〈 Equation 4 〉$$

In the equations 3 and 4, n is any integer. FIG. 5 illustrates an example of the angle θf in the equation 4. That is, the angle θf in the equation 4 is an exactly intermediate angle between the angle θt and the angle θs. If the phase difference R is set as in the equation 2, as to a wavelength, in the vicinity of the wavelength λ, of the external light, the direction of the partially polarized light corresponds to a direction DWP corresponding to the P polarization of the windshield before the transmission through the retardation plate 50, and corresponds to a direction D2 corresponding to the light-shielding axis 42 after the transmission. Even in the case of a disposition in which the retardation plate 50 is rotated by 90° from the state of FIG. 5, since the angle θf satisfies the condition of the equation 4, the same applies to this disposition.

FIG. 6 illustrates the range of the angle θf expressed by the equation 3 in a 90° cycle, using dots. That is, if the angle θf is set in the range expressed by the equation 3, the direction of the partially polarized light is away from the transmission axis 41 and close to the light-shielding axis 42, in comparison with the case where the retardation plate 50 is not disposed. In FIG. 6, solid lines indicate the angle θf satisfying the equation 4.

Further, in FIG. 4, the polarization axis 21, the transmission axis 41, the light-shielding axis 42, the fast axis 51, and the slow axis 52 are formed by the corresponding elements 10, 40, and 50 in reality, but are shown at positions apart from the optical path OP to ensure viewability. Further, the polarization direction of the light of the image is indicated by each arrow overlapping the optical path OP, and the polarization state of the external light is indicated by a circle or an ellipse.

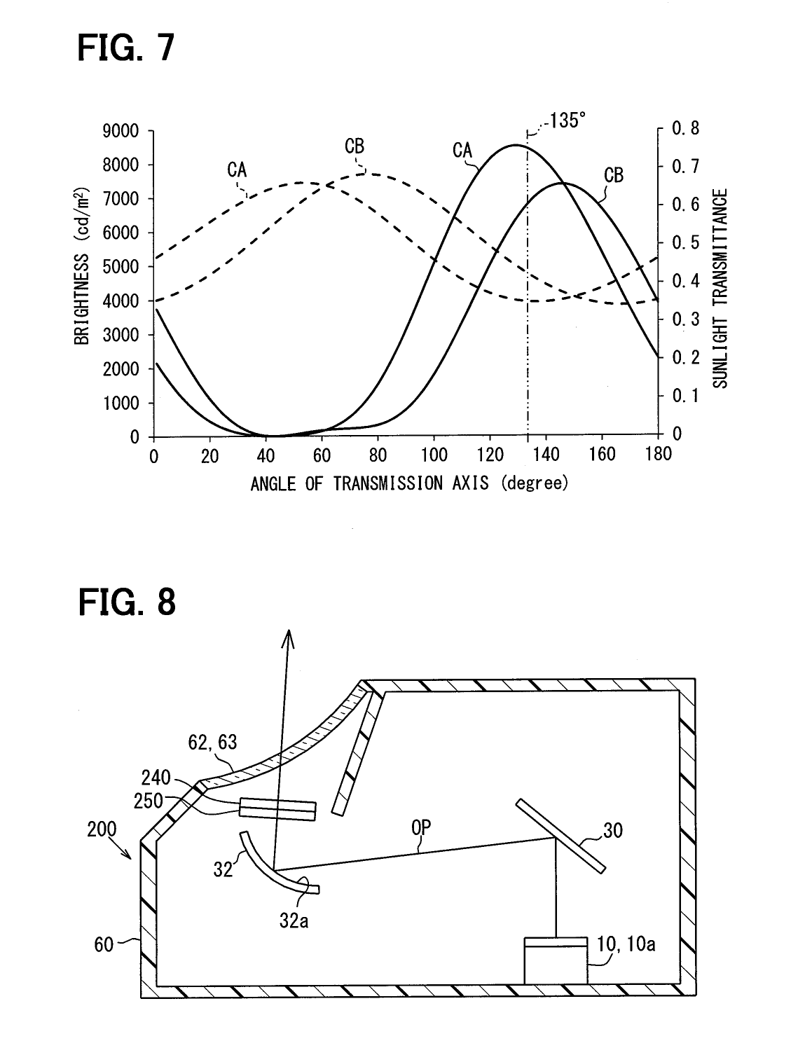

Next, the simulation result of the brightness of virtual image display and sunlight transmittance by the inventors will be described with reference to FIG. 7. FIG. 7 is a graph comparing a configuration CA corresponding to the HUD device 100 according to the first embodiment with a configuration CB in which the retardation plate 50 is removed from the HUD device 100 as a comparison example. Further, FIG. 7 shows the case of changing the angle of the transmission axis of the polarizing plate in each of the configurations CA and CB. In FIG. 7, the brightness of the virtual image display is indicated by solid lines. The sunlight transmittance indicated by broken lines in FIG. 7 is the transmittance of the polarizing plate, and for example, full transmission is represented as 1.

As detailed conditions of the simulation, assuming that the angle of a direction corresponding to the horizontal direction of the image in the projector is 0°, the angle θt is set to 135°, and the angle θs is set to 169°. Further, in the configuration CA, the angle θf is set to 152° so as to satisfy the equation 4.

In the comparison of the brightness of the virtual image display, the maximum brightness is 8,000 cd/m² or less in the configuration CB, whereas the maximum brightness is 8,000 cd/m² or more in the configuration CA. Since the transmission axis 41 of the polarizing plate 40 is disposed in the direction DT (corresponding to 135° in the configuration CA) corresponding to the polarization axis 21 in the first embodiment, a brightness of 8,000 cd/m² or more is obtained as seen in the figure.

In the configuration CB, the angle of the transmission axis at the maximum brightness is deviated from the angle of the transmission axis at the minimum sunlight transmittance. On the other hand, in the configuration CA, the angle of the transmission axis at the maximum brightness roughly matches the angle of the transmission axis at the minimum sunlight transmittance.

Further, in this vicinity, the brightness of the virtual image display and the sunlight transmittance do not change sharply with respect to the angle of the transmission axis, as seen in the figure. Therefore, in the configuration CA corresponding to the first embodiment, as long as the transmission axis of the polarizing plate is disposed in the direction corresponding to the polarization axis, even in the case of an angle difference of about 10°, it is possible to achieve sufficiently higher brightness and lower sunlight transmittance than in the configuration CB.

(Operational Effect)

Hereinafter, operational effects of the above-described first embodiment will be described.

According to the first embodiment, the retardation plate 50 is disposed between the polarizing plate 40 and the windshield 3 on the optical path OP formed by the light of the image projected by the projector 10. In the case where the external light transmitted through the windshield 3 enters the HUD device 100 with this disposition, e.g. in the state of being partially polarized in the direction DWP corresponding to the P polarization of the windshield 3; since the fast axis direction DF of the retardation plate 50 intersects with the direction DWS corresponding to the S polarization of the windshield 3, it is possible to perform the setting of changing the direction of the partially polarized light of the external light in matching with the polarizing plate 40. Further, since the direction DT corresponding to the polarization axis 21 and the direction D1 corresponding to the transmission axis 41 intersect with the fast axis direction DF, it is possible to perform the setting of efficiently shielding by the polarizing plate 40 the external light traveling toward the projector 10 and efficiently transmitting the light of the image from the projector 10 toward the windshield 3. Therefore, it is possible to provide the HUD device 100 that suppresses temperature rise of the projector 10 while suppressing brightness reduction of the virtual image display.

Further, according to the first embodiment, the transmission axis 41 is disposed in the direction corresponding to the polarization axis 21, and the fast axis direction DF is set so as to satisfy the equation 3. According to this, when the external light transmitted through the windshield 3 enters the retardation plate 50, e.g. in the state of being partially polarized in the direction DWP corresponding to the P polarization of the windshield 3, the direction of the partially polarized light of the external light is moved away from the transmission axis 41 surely at the time of entering the polarizing plate 40. Therefore, it is possible to efficiently shield by the polarizing plate 40 the external light traveling toward the projector 10 and suppress the temperature rise of the projector 10. In addition, the polarization direction of the light of the image is moved close to the S polarization of the windshield 3 by the retardation plate 50 after the light is efficiently transmitted through the polarizing plate 40, and the light is reflected by the windshield 3 with high reflectance, thereby making it possible to suppress the brightness reduction of the virtual image display.

Further, according to the first embodiment, the fast axis direction DF is set so as to satisfy the equation 4. When the external light transmitted through the windshield 3 enters the polarizing plate 40, e.g. in the state of being partially polarized in the direction DWP corresponding to the P polarization of the windshield 3, the external light enters the polarizing plate 40 in the state where the direction of the partially polarized light is away from the transmission axis 41. Accordingly, the light of the image is transmitted through the polarizing plate 40 in the state where the polarization direction corresponds to the transmission axis 41, and then reflected as the S polarized light by the windshield 3. Therefore, it is possible to provide the HUD device 100 that suppresses the temperature rise of the projector 10 while suppressing the brightness reduction of the virtual image display.

Further, according to the first embodiment, since the phase difference R is set so as to satisfy the following equation 1, it is possible to surely obtain the effect of suppressing the brightness reduction of the virtual image display and the temperature rise of the projector 10.

Further, according to the first embodiment, since the phase difference R is set so as to satisfy the following equation 2, it is possible to more surely obtain the effect of suppressing the brightness reduction of the virtual image display and the temperature rise of the projector 10.

Further, according to the first embodiment, since the polarizing plate 40 and the retardation plate 50 are stuck together into an integrated plate, it is easy to enhance the accuracy of the positional relation between the direction D1 corresponding to the transmission axis 41 and the fast axis direction DF. Therefore, it is possible to easily provide the HUD device 100 that suppresses the temperature rise of the projector 10 while suppressing the brightness reduction of the virtual image display.

### Second Embodiment

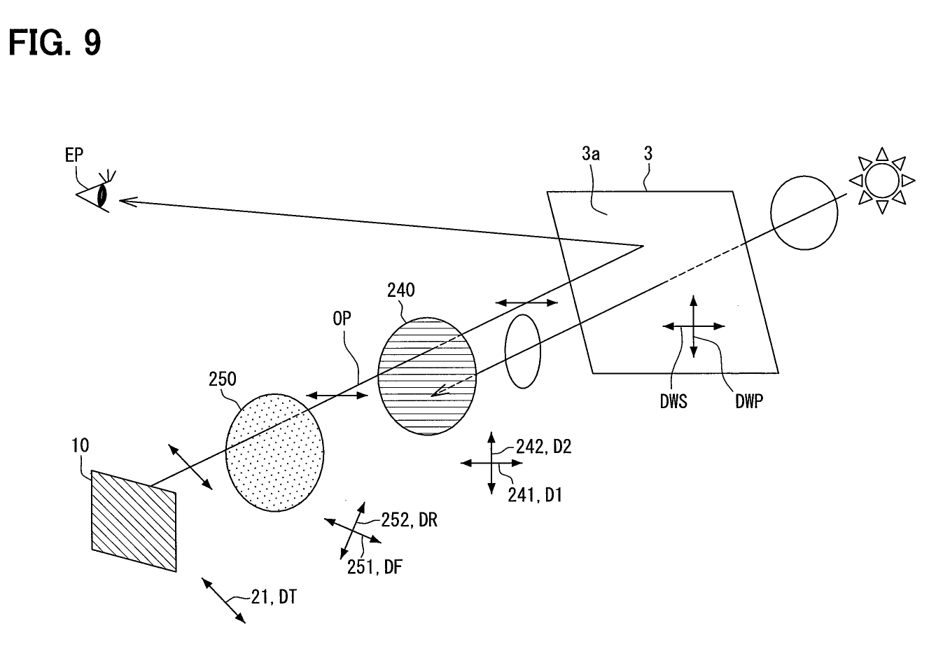

As shown in FIGS. 8 to 9, a second embodiment of the present disclosure is a modification of the first embodiment. The differences of the second embodiment from the first embodiment will be mainly described.

As shown in FIG. 8, a retardation plate 250 in an HUD device 200 according to the second embodiment is disposed between the projector 10 and a polarizing plate 240 on the optical path OP, and is a phase shifter formed like a flat plate. More specifically, the retardation plate 250 is disposed between the concave mirror 32 and the polarizing plate 240. The retardation plate 250 has a property of changing the polarization direction of transmitted light by producing a phase difference, as in the first embodiment. By the setting of the direction (hereinafter referred to as a fast axis direction DF) of a fast axis 251 substantially orthogonal to a slow axis 252, the light of an image transmitted through the retardation plate 250 changes the polarization direction, and enters the polarizing plate 240.

The polarizing plate 240 according to the second embodiment is disposed between the retardation plate 250 and the windshield 3 on the optical path OP, and is a polarizer formed like a sheet. By the setting of a transmission axis 241 described later, the light of the image is transmitted through the polarizing plate 240, and then enters the windshield 3 through the dustproof window 62.

The setting of the fast axis direction DF of the retardation plate 250 will be described in detail with reference to FIG. 9. As in the first embodiment, the fast axis direction DF according to the second embodiment is set so as to intersect with the direction DT corresponding to the polarization axis 21 of the projector 10, the direction D1 corresponding to the transmission axis 241 of the polarizing plate 240, and the direction DWS corresponding to the S polarization of the windshield 3. As a supplement, as in the first embodiment, there is a correspondence relation in which the directions DT, D1, and DWS intersect with the fast axis direction DF on the plate surface of the retardation plate 250.

The light of the image from the projector 10 enters the polarizing plate 240 according to the second embodiment. On the other hand, external light such as sunlight enters the polarizing plate 240 through the windshield 3. The external light becomes partially polarized light including a lot of P polarization components of the windshield 3, as in the first embodiment.

The transmission axis 241 of the polarizing plate 240 is disposed in the direction DWS corresponding to the S polarization of the windshield 3, and, for example, matches the direction DWS. In this second embodiment, the angle θf of the fast axis direction DF of the retardation plate 250 is set in a range expressed by the following equation 5, using the angle θt of the direction DT corresponding to the polarization axis 21 and the angle θs of the direction DWS corresponding to the S polarization of the windshield 3.

$$\frac{( {θ}_{s} + {θ}_{t} )}{2} + 90 \cdot n - 22.5 < {θ}_{f} < \frac{( {θ}_{s} + {θ}_{t} )}{2} + 90 \cdot n + 22.5 \qquad 〈 Equation 5 〉$$

Further, it is preferable that the angle θf is set so as to satisfy the following equation 6, and in this embodiment, the angle θf is set in this way.

$${θ}_{f} = \frac{( {θ}_{s} + {θ}_{t} )}{2} + 90 \cdot n \qquad 〈 Equation 6 〉$$

In the equations 5 and 6, n is any integer. That is, the angle θf in the equation 6 is an exactly intermediate angle between the angle θt and the angle θs. If the phase difference R is set as in the first embodiment, as to a wavelength, in the vicinity of the wavelength λ, of the external light, the polarization direction of the light of the image matches the transmission axis 241 due to the property of the retardation plate 250. Further, if the angle θf is set in the range expressed by the equation 5, the polarization direction of the light of the image is away from a light-shielding axis 242 and close to the transmission axis 241, in comparison with the case where the retardation plate 250 is not disposed.

According to the second embodiment, the retardation plate 250 is disposed between the projector 10 and the polarizing plate 240 on the optical path OP formed by the light of the image projected by the projector 10. In the HUD device 200 with this disposition, since the fast axis direction DF of the retardation plate 250 intersects with the direction corresponding to the polarization axis 21, it is possible to perform the setting of changing the polarization direction of the light of the image projected by the projector 10 in matching with the polarizing plate 240. Further, in the case where the external light transmitted through the windshield 3 enters the polarizing plate 240, e.g. in the state of being partially polarized in the direction DWP corresponding to the P polarization of the windshield 3; since the direction D1 corresponding to the transmission axis 241 and the direction DWS corresponding to the S polarization of the windshield 3 intersect with the fast axis direction DF, it is possible to perform the setting of efficiently shielding the external light traveling toward the projector 10 and efficiently transmitting the light of the image from the projector 10 toward the windshield 3. Therefore, it is possible to provide the HUD device 200 that suppresses temperature rise of the projector 10 while suppressing brightness reduction of the virtual image display.

Further, according to the second embodiment, the transmission axis 241 is disposed in the direction DWS corresponding to the S polarization of the windshield 3, and the fast axis direction DF is set so as to satisfy the equation 5. According to this, the polarization direction of the light of the image is moved close to the transmission axis 241 and the S polarization of the windshield 3 by the retardation plate 250. Thus, the light of the image is efficiently transmitted through the polarizing plate 240, and then is reflected by the windshield 3 with high reflectance, thereby making it possible to suppress the brightness reduction of the virtual image display. In addition, when the external light transmitted through the windshield 3 enters the polarizing plate 240, e.g. in the state of being partially polarized in the direction corresponding to the P polarization of the windshield 3, the external light is surely shielded, thereby making it possible to suppress the temperature rise of the projector 10.

### OTHER EMBODIMENTS

While the present disclosure has been described in accordance with the above embodiments, it is understood that the present disclosure is not limited to the above embodiments and structures. The present disclosure embraces various changes and modifications within the range of equivalency. In addition, various combinations and modifications and other combinations and modifications including only one element or more or less than one element are within the scope and sprit of the present disclosure.

Specifically, as a first modification, the polarizing plate 40 and the retardation plate 50 may be disposed separated from each other instead of being stuck together.

As a second modification, the polarizing plate 40 or the retardation plate 50 may be disposed between the projector 10 and the concave mirror 32 on the optical path OP. As an example, the polarizing plate 40 and the retardation plate 50 formed like the integrated plate may be disposed between the projector 10 and the plane mirror 30 or between the plane mirror 30 and the concave mirror 32. As another example, the polarizing plate 40 and the retardation plate 50 may be disposed, with the plane mirror 30 or the concave mirror 32 in between, on the optical path OP.

As a third modification, an optical element such as a lens or a mirror may be additionally disposed on the optical path OP. The detailed configuration of the plane mirror 30 or the concave mirror 32 may be changed, or the plane mirror 30 or the concave mirror 32 may be omitted.

What is claimed is:

1. A head-up display device that is to be mounted in a vehicle and to virtually display an image to be viewable by an occupant by projecting the image on a light-transmissive projection member, the head-up display device comprising:
a projector that projects the image as light polarized in a direction of a polarization axis;
a polarizer that is disposed on an optical path of the light of the image and has a property of transmitting light polarized along a transmission axis; and
a phase shifter that is disposed between the polarizer and the projection member on the optical path and has a property of changing a polarization direction of transmitted light by producing a phase difference;
a cold mirror that is disposed on the optical path, includes a light-transmissive substrate and a dielectric multilayer film on a surface of the light-transmissive substrate, and reflects the light of the image,
wherein the phase shifter is disposed between the cold mirror on the optical path and the projection member, and
wherein a fast axis direction of the phase shifter intersects with a direction corresponding to the polarization axis, a direction corresponding to the transmission axis, and a direction corresponding to S polarization of the projection member.

2. The head-up display device according to claim 1, wherein
the transmission axis is disposed in the direction corresponding to the polarization axis, and
when an angle of the fast axis direction is defined as θf, an angle of the direction corresponding to the polarization axis is defined as θt, an angle of the direction corresponding to the direction corresponding to the S polarization of the projection member is defined as θs, and n is defined as any integer, a following equation 3 is satisfied:
$$\frac{( {θ}_{s} + {θ}_{t} )}{2} + 90 \cdot n - 22.5 < {θ}_{f} < \frac{( {θ}_{s} + {θ}_{t} )}{2} + 90 \cdot n + 22.5 \qquad 〈 Equation 3 〉$$

3. A head-up display device that is to be mounted in a vehicle and to virtually display an image to be viewable by an occupant by projecting the image on a light-transmissive projection member, the head-up display device comprising:
a projector that projects the image as light polarized in a direction corresponding to a polarization axis;
a polarizer that is disposed on an optical path of the light of the image and has a property of transmitting light polarized along a transmission axis; and
a phase shifter that is disposed between the projector and the polarizer on the optical path and has a property of changing a polarization direction of transmitted light by producing a phase difference,
wherein a fast axis direction of the phase shifter intersects with a direction corresponding to the polarization axis, a direction corresponding to the transmission axis, and a direction corresponding to S polarization of the projection member.

4. The head-up display device according to claim 3, wherein
the transmission axis is disposed in the direction corresponding to the S polarization of the projection member, and
when an angle of the fast axis direction is defined as θf, an angle of the direction corresponding to the polarization axis is defined as θt, an angle of the direction corresponding to the S polarization of the projection member is defined as θs, and n is defined as any integer, a following equation 5 is satisfied:
$$\frac{( {θ}_{s} + {θ}_{t} )}{2} + 90 \cdot n - 22.5 < {θ}_{f} < \frac{( {θ}_{s} + {θ}_{t} )}{2} + 90 \cdot n + 22.5 \qquad 〈 Equation 5 〉$$

5. The head-up display device according to claim 2, wherein a following equation 4 is satisfied:
$${θ}_{f} = \frac{( {θ}_{s} + {θ}_{t} )}{2} + 90 \cdot n \qquad 〈 Equation 4 〉$$

6. The head-up display device according to claim 3, wherein when the phase difference is defined as R, a wavelength of the light of the image is defined as λ, and m is defined as any integer of 0 or more, a following equation 1 is satisfied:
(¼+m)·λ<R<(¾+m)·λ <Equation 1>

7. The head-up display device according to claim 6, wherein a following equation 2 is satisfied:
R=(½+m)·λ <Equation 2>

8. The head-up display device according to claim 3, wherein the polarizer and the phase shifter are stuck together into an integrated plate.

9. The head-up display device according to claim 2, wherein a following equation 4 is satisfied:
$${θ}_{f} = \frac{( {θ}_{s} + {θ}_{t} )}{2} + 90 \cdot n \qquad 〈 Equation 4 〉$$

10. The head-up display device according to claim 1, wherein when the phase difference is defined as R, a wavelength of the light of the image is defined as λ, and m is defined as any integer of 0 or more, a following equation 1 is satisfied:
(¼+m)·λ<R<(¾+m)·λ <Equation 1>

11. The head-up display device according to claim 10, wherein a following equation 2 is satisfied:
R=(½+m)·λ <Equation 2>

12. The head-up display device according to claim 1, wherein the polarizer and the phase shifter are stuck together into an integrated plate.
